(19) United States
(12) Patent Application Publication
(10) Pub. No.: US 2007/0198610 A1
(43) Pub. Date: Aug. 23, 2007

(54) SYSTEM AND METHOD FOR BACKING UP A DATABASE

(75) Inventors: PU-YANG YEH, Tu-Cheng (TW); HUA-YU ZHOU, Shenzhen (CN); LIANG LI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/563,156

(22) Filed: Nov. 25, 2006

(30) Foreign Application Priority Data
Feb. 17, 2006 (CN) 200610033836.7

(51) Int. Cl. G06F 17/30

(52) U.S. Cl. 707/204

(57) ABSTRACT

An exemplary system for backing up a database is disclosed. The system includes at least one remote server (1), and an application server (4) configured between the database and the at least remote server. A related method is also disclosed. The method includes the steps of: receiving parameters; backing up a database and generating a local backup file in an application server; and transferring the local backup file to a remote server and generating a remote backup file in the remote server.

### BACKGROUND OF THE INVENTION

1. Field of the Invention

The present invention is generally related to systems and methods for backing up data, and more particularly to a system and method for backing up a database.

2. Description of Related Art

A database system is very important in today's world. A database is essentially a collection of information that can be queried for desired information by a computer operator. Database security is a concern for many enterprises; incidents of data misuse and theft are increasing, and recent regulations have mandated strict requirements for data security, data privacy, and data integrity. Generally speaking, most information (such as customer data, production data, and the likes) in a database is stored in an application server of an enterprise and may not have any hard-copy back-ups. Therefore, security related to databases and data stored therein is a growing importance. Moreover, many present database security techniques can be breached through Trojan Horse and/or by software hackers with malicious intent, because they do not provide a good enough comprehensive level of security.

There is a need for all database systems to periodically produce a copy of the contents of the stored information in the systems. This is because the stored information in a database changes over time. A copy of the contents of the database at some point in time assures that the database can be restored to the state existing at that point in time in case of a malfunction that corrupts the database. However, in recent years, in order to actualize backing up a database automatically and remotely, a backup server and backup software are required to be purchased, thus having a high equipment cost and a high management cost. Furthermore, the database and the backup server are required to base on the same operation system in conventional backup operations. For example, a database based on a Windows operating system only adopts a Windows backup server to perform the backup operation.

Therefore, what is needed is a system and method for backing up a database, which can accomplish backing up the database based on any operating system remotely and automatically, thus having the features of availability and security.

### SUMMARY OF THE INVENTION

One embodiment provides a system for backing up a database which stores kinds of data. The system includes at least one remote server and an application server configured between the database and the at least one remote server. The application server includes a receiving module configured for receiving parameters, the parameters comprising a first time schedule for backing up the database and generating a local backup file, a second time schedule for transferring the local backup file to the at least one remote server, and login information for logining to the at least one remote server; a backup module configured for backing up the database according to the first time schedule, and generating the local backup file in the application server; and a transferring module configured for transferring the local backup file to the at least one remote server according to the second time schedule and the login information for logining to the at least one remote server, and generating a remote backup file in the at least one remote server.

Another embodiment provides a computer-based method for backing up a database. The method includes the steps of: (a) receiving parameters, the parameters comprising a first time schedule for backing up a database and generating a local backup file, a second time schedule for transferring the local backup file to a remote server, and login information for logining to the remote server; (b) backing up the database if it is time to backup the database according to the first time schedule, and generating the local backup file in an application server connected with the database; and (c) transferring the local backup file to the remote server if it is time to transfer the local backup file to the remote server according to the second time schedule and the login information for logining to the remote server login, and generating a remote backup file in the remote server.

Other objects, advantages and novel features of the embodiments will be drawn from the following detailed description together with the attached drawings, in which:

### BRIEF DESCRIPTION OF THE DRAWINGS

FIG. 1 is a schematic diagram of a hardware configuration of a system for backing up a database in accordance with a preferred embodiment;

FIG. 2 is a schematic diagram of main function modules of the application server of the system of FIG. 1; and

FIG. 3 is a flow chart of a preferred method for backing up a database by utilizing the system of FIG. 1.

### DETAILED DESCRIPTION OF THE INVENTION

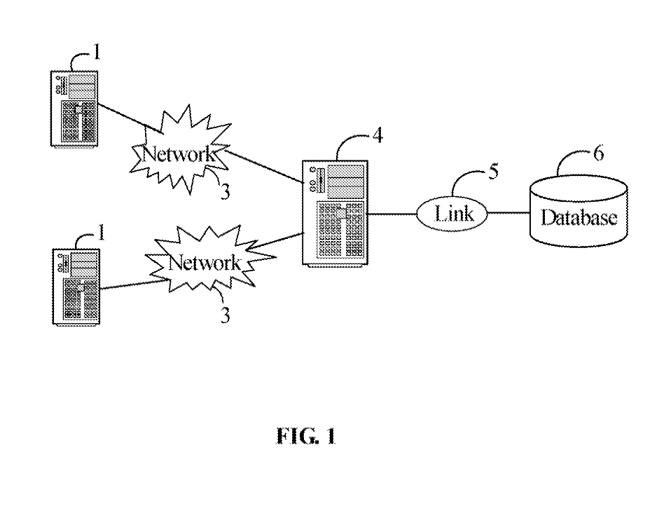

FIG. 1 is a schematic diagram of a hardware configuration of a system for backing up a database (hereinafter, “the system”) in accordance with a preferred embodiment. The system includes at least one remote server 1. In the preferred embodiment, there are two remote servers 1. The remote servers 1 are located at different locations, such as in China or in America. The system further includes an application server 4. The application server 4 is configured between the database 6 and the remote servers 1. Each remote server 1 is connected with the application server 4 via a network 3. The network 3 can be an intranet, the Internet, or any other suitable type of communication network based on Transport Control Protocol/Internet Protocol (TCP/IP), which supports the File Transfer Protocol (FTP). The application server 4 is connected with the database 6 through a link 5. The link 5 may be an open database connectivity (ODBC), or a Java database connectivity (JDBC).

The database 6 is configured for storing different kinds of data, including customer data, production data, design data, and the likes. In the preferred embodiment, the database 6 is an Oracle database, which includes an Enterprise Resource Planning (ERP) system. The application server 4 is typically a server computer having several function modules installed therein, configured for performing an automatic backup of the database 6 via disk operating system (DOS), thus generating a local backup file in the application server 4, and transferring the local backup file to each remote server 1. The application server 4 is further configured for recovering data from the local backup file into the database 6 via DOS automatically, when the data in the database 6 contains abnormities, for example, the data is not integrated.

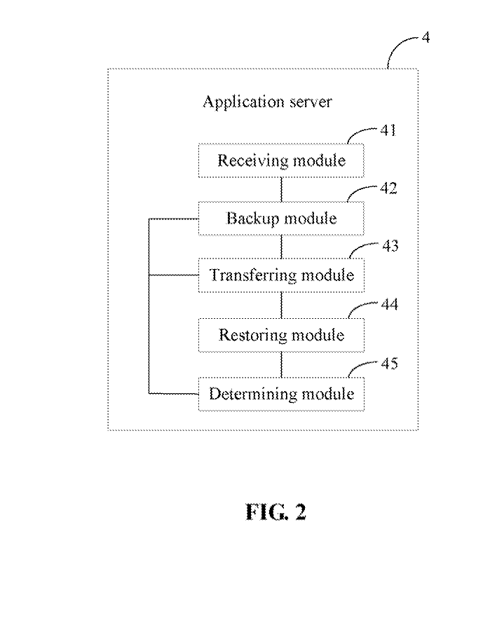

FIG. 2 is a schematic diagram of main function modules of the application server 4. The application server 4 includes a receiving module 41, a backup module 42, a transferring module 43, a restoring module 44, and a determining module 45.

The receiving module 41 is configured for receiving parameters, which include a first time schedule for backing up the database 6 and generating the local backup file, a second time schedule for transferring the local backup file to each remote server 1, and login information for logining to each remote server. The login information includes Internet Protocol (IP) address of each remote server 1, a port number of each remote server 1, and a login name and a login password of each remote server 1.

The backup module 42 is configured for backing up the database 6 and generating the local backup file in the application server 4 according to the first time schedule by running a database backup program in the application server 4 via disk operating system (DOS). The local backup file is stored with a name containing a backup date-time of the local backup file. In addition, the backup module 42 is further configured for generating a backup log file while generating the local backup file. The backup log file is configured in the application server 4 for recording the success flag indicating that the local backup file has been backed up successfully, or recording the failure flag indicating that the local backup file has been backed up unsuccessfully.

The transferring module 43 is configured for transferring the local backup file to each remote server 1 according to the second time schedule and the login information for logining to each remote server by running a database transfer program in the application server 4 via DOS automatically, and generating a remote backup file in each remote server 1. The remote backup file is stored with a name containing a transfer date-time of the remote backup file. In addition, the transferring module 43 is also configured for generating a transfer log file while generating the remote backup file. The transfer log file is configured in the application server 4 for recording a success flag indicating that the local backup file has been transferred successfully, or recording a failure flag indicating that the local backup file has been transferred unsuccessfully.

The restoring module 44 is configured for recovering data in the local backup file in the application server 4 into the database 6 by running a database restoring program in the application server 7 via DOS automatically, when the data in the database 6 contains abnormities, for example, the data is not integrated.

The determining module 45 is configured for detecting whether it is time to backup the database 6 according to the first time schedule received by the receiving module 41, and also configured for detecting whether it is time to transfer the local backup file to each remote server 1 according to the second time schedule received by the receiving module 41.

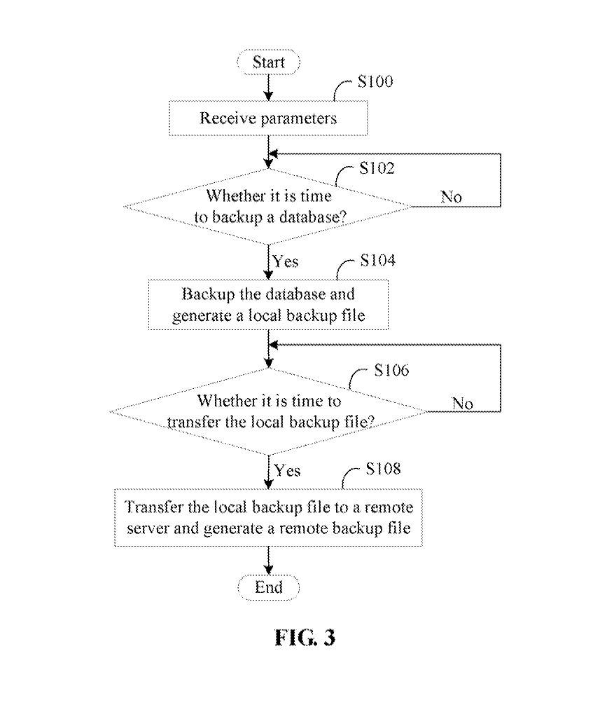

FIG. 3 is a flow chart of a preferred method for backing up the database 6. In step S100, the receiving module 41 receives parameters that include a first time schedule for backing up the database 6 and generating the local backup file, a second time schedule for transferring the local backup file to each remote server 1, and the login information for logining to each remote server. The login information includes the Internet Protocol (IP) address, the port number of each remote server 1, and the login name and the login password of each remote server 1.

In step S102, the determining module 45 detects whether it is time to backup the database 6 according to the first time schedule. If it is not time to backup the database 6, the procedure returns to step S102.

If it is time to backup the database 6, in step S104, the backup module 42 backs up the database 6 and generates the local backup file in the application server 4 according to the first time schedule by running the database backup program in the application server 4 via disk operating system (DOS). The local backup data is stored with the name containing the backup date-time of the local backup data. In this step the backup module 42 also generates the backup log file in the application server 4 for recording the success flag indicating that the local backup file has been backed up successfully, or recording the failure flag indicating that the local backup file has been backed up unsuccessfully.

In step S106, the determining module 45 detects whether it is time to transfer the local backup file to each remote server 1 according to the second time schedule. If it is not the time to transfer the local backup file, the procedure returns to step S106.

If it is time to transfer the local backup file, in step S108, the transferring module 43 transfers the local backup file to each remote server 1 according to the second time schedule and the login information for logining to each remote server by running the database transfer program in the application server 4 via DOS automatically, and generates the remote backup file in each remote server 1. The remote backup file is stored with the name containing the transfer date-time of the remote backup file. In this step, the transferring module 43 also generates the transfer log file in the application server 4 for recording the success flag indicating that the local backup file has been transferred successfully, or recording the failure flag indicating that the local backup file has been transferred unsuccessfully.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for backing up a database which stores kinds of data, the system comprising at least one remote server and an application server configured between the database and the at least one remote server, the application server comprising:
a receiving module configured for receiving parameters, the parameters comprising a first time schedule for backing up the database and generating a local backup file, a second time schedule for transferring the local backup file to the at least one remote server, and login information for logining to the at least one remote server;
a backup module configured for backing up the database according to the first time schedule, and generating the local backup file in the application server; and
a transferring module configured for transferring the local backup file to the remote server according to the second time schedule and the login information for logining to the at least one remote server, and generating a remote backup file in the at least one remote server.

2. The system according to claim 1, wherein the application server further comprises a determining module configured for detecting whether it is time to backup the database according to the first time schedule, and detecting whether it is time to transfer the local backup file to the at least one remote server according to the second time schedule.

3. The system according to claim 1, wherein the application server further comprises a restoring module configured for recovering the database.

4. The system according to claim 1, wherein the backup module is further configured for generating a backup log file in the application server while generating the local backup file.

5. The system according to claim 1, wherein the transferring module is further configured for generating a transfer log file in the application server while generating the remote backup file.

6. The system according to claim 1, wherein the login information for logining to the at least one remote server comprises an Internet Protocol address of the at least one remote server, a port number of the at least one remote server, and a login name and a login password of the at least one remote server.

7. A computer-based method for backing up a database, the method comprising:
receiving parameters, the parameters comprising a first time schedule for backing up the database and generating a local backup file, a second time schedule for transferring the local backup file to a remote server, and login information for logining to the remote server;
backing up the database if it is time to backup the database according to the first time schedule, and generating the local backup file in an application server connected with the database; and
transferring the local backup file to the remote server if it is time to transfer the local backup file to the remote server according to the second time schedule and the login information for logining to the remote server, and generating a remote backup file in the remote server.

8. The method according to claim 7, further comprising the step of:
restoring the database when data in the database contains abnormities.

9. The method according to claim 7, further comprising the step of:
generating a backup log file in the application server while generating the local backup file.

10. The method according to claim 7, further comprising the step of:
generating a transfer log file in the application server while generating the remote backup file.

11. The method according to claim 7, wherein the login information for logining to the remote server comprises an Internet Protocol address of the remote server, a port number of the remote server, and a login name and a login password of the remote server.
